(19) United States
(12) Patent Application Publication
(10) Pub. No.: US 2016/0294846 A1
(43) Pub. Date: Oct. 6, 2016

(54) METHOD OF AND SYSTEM FOR PRESENTING TRUST INFORMATION IN RESPECT OF WEB RESOURCES USING FAVICONS

(71) Applicant: YANDEX EUROPE AG, Luzern (CH)

(72) Inventors: Taras Anatolievich SHAROV, Obninsk, Kaluga region (RU); Roman Antonovich VORONEZHSKIY, Moscow (RU); Andrey Grigorievich PLAKHOV, Sergiev Posad, Moscow Region (RU)

(21) Appl. No.: 15/036,072

(22) PCT Filed: Nov. 15, 2013
(86) PCT No.: PCT/RU2013/001025

§ 371 Date: May 12, 2016

(51) Int. Cl. H04L 29/06; G06F 17/30

(52) U.S. Cl. CPC H04L 63/126; G06F 17/30554; G06F 17/30867; G06F 17/3053; H04L 63/123; H04L 63/0823

(57) ABSTRACT

Method of presenting trust information in respect of web resources on a display of an electronic device, the method comprising: determining a first visual attribute of a first favicon corresponding to a first web resource, the first visual attribute being indicative of a first trust score in respect of the first web resource, and a second visual attribute of a second favicon corresponding to a second web resource, the second attribute being indicative of a second trust score in respect of the second web resource: and causing the display to display a first link to the first web resource, the first link including the first favicon, and a second link to the second web resource, the second link including the second favicon. System and computer-readable program instructions for executing method are also disclosed.

### CROSS-REFERENCE

None

### FIELD OF THE TECHNOLOGY

The present technology relates to presenting trust information in respect of web resources.

### BACKGROUND

As usage of the Internet has increased, so too has the opportunity for hijacking of information shared either directly or indirectly with various web resources such as websites or web pages. While a majority of web resources may be operated with honest intentions, the adequacy of safeguards for protecting the information transacted with them may vary, such that some honestly-operated web resources are more worthy of a potential user's trust than others. Other web resources are not operated with honesty and transparency, but rather with the malicious intention of deceiving users in order to obtain their personal information, infiltrate their computer systems, or otherwise cause harm either to them or to others. For example, a fraudulent website may replicate sufficient features of a trusted website to give users the illusion that they are dealing with the trusted website, thereby gaining their trust and leading them to reveal confidential information such as banking information. These and other such maliciously-operated web resources are not trustworthy and are preferably to be avoided by users.

Various techniques exist for measuring the trustworthiness of web resources and reporting those measures to potential users in order to guide them in their decisions as to whether or not to share information or otherwise interact with those web resources. For example, a Finland-based service called WOT™ (short for “web of trust”) offers a browser plugin for a variety of popular web browsers which causes the browser to display predefined icons next to hyperlinks pointing to websites, the hyperlinks being selectable by the user to cause the browser to navigate to the corresponding website and each of the predefined icons being representative of a “reputation” of the corresponding website. The measurement of website reputation is achieved through “crowdsourcing”, whereby users of the browser plugin may themselves assess websites in order to influence the subsequent reputation of those websites.

While such conventional technologies in the field of presenting trust information of web resources may be useful, there remains room for improvement.

### SUMMARY

It is thus an object of the present technology to ameliorate at least some of the inconveniences present in the prior art. The present technology comprises a novel means of rapidly and efficiently conveying trust information in respect of web resources to potential users of those resources via a novel use of “favicons” corresponding to those web resources.

A favicon is an icon associated with a Web resource such as a webpage or website. More specifically, the Document Object Model (DOM) specifies that a header link with a relation of “shortcut icon” can specify the uniform resource identifier (URI) of an icon for that webpage. An older standard of having a file named “favicon.ico” may also be used. Web browsers use the URI or a default location to request and receive the favicon from a web resource.

Today, favicons are commonly used as an appealing visual supplement to traditional text-based Internet hyperlinks selectable via a web browser to cause the browser to navigate to a linked web resource. Favicons thus allow web resource operators to convey a simple and visually-enticing representation of their web resource in order to attract potential users and retain existing ones. Users benefit not only from the greater visual appeal of links which include such favicons, but also from the greater ease of identifying commonly-used web resources by reference to their increasingly familiar favicons. Favicons thus perform a similar function in respect of web resources as brands, designs, logos, and packaging in respect of traditional goods and services. In other words, conventionally, favicons serve as a direct conduit of branding information from operators of web resources to potential and existing users of those web resources.

The present technology disrupts the conventional use of favicons by using favicons as a means of indicating trust scores in respect of the web resources to which they correspond, wherein those trust scores may not be under the control of the operators of those web resources. More specifically, the present technology comprises causing displaying of each of a plurality of links to web resources, each link including a favicon displayed with a visual attribute indicative of a trust score of the corresponding web resource. The present technology thus efficiently conveys trust information in respect of the web resource via a novel use of the favicon running counter to the conventional use of favicons as direct conduits of branding information. Moreover, various implementations of the present technology may convey trust information without requiring installation of a browser plugin, thereby increasing ease of adoption, and without displaying an additional icon apart from the favicon, thereby reducing visual clutter and overall display area, which is at a premium especially on mobile device displays.

Thus, in one aspect, implementations of the present technology provide a method of presenting trust information in respect of web resources on a display of an electronic device, the method comprising:

determining a first visual attribute of a first favicon corresponding to a first web resource, the first visual attribute being indicative of a first trust score in respect of the first web resource, and a second visual attribute of a second favicon corresponding to a second web resource, the second attribute being indicative of a second trust score in respect of the second web resource; and

causing the display to display a first link to the first web resource, the first link including the first favicon, and a second link to the second web resource, the second link including the second favicon.

In some implementations, the step of determining the first visual attribute and the second visual attribute is executed by the electronic device which displays the first link and the second link on its display. The electronic device executing the method may be a standalone device or a client device in communication with one or more servers via a communications network. Thus, in some implementations:
determining the first visual attribute and the second visual attribute is determining, by the electronic device, the first visual attribute and the second visual attribute; and
causing the display to display the first link and the second link is displaying, by the electronic device, the first link and the second link on the display.

In other implementations, the step of determining the first visual attribute and the second visual attribute is executed by a server in communication with the electronic device, which causes displaying of the first link and the second link on the display of the electronic device by sending instructions for displaying them to the electronic device. Thus, in some implementations:
determining the first visual attribute and the second visual attribute is determining, by a server in communication with the electronic device via a communications network, the first visual attribute and the second visual attribute; and
causing the display to display the first link and the second link is sending, by the server to the electronic device via the communications network, instructions for displaying the first link and the second link.

In various implementations, determining the first visual attribute and the second visual attribute is receiving an indication of the first visual attribute and an indication of the second visual attribute from a server via a communications network. In other implementations, determining the first visual attribute and the second visual attribute comprises receiving an indication of the first trust score and an indication of the second trust score from a trust score server and setting the first visual attribute based on the first trust score and the second virtual attribute based on the second trust score. In other implementations, determining the first visual attribute and the second visual attribute comprises calculating the first trust score based on information about the first web resource and the second trust score based on information about the second web resource and setting the first visual attribute based on the first trust score and the second virtual attribute based on the second trust score.

In various implementations, the first link and second link are displayed concurrently on the display. Thus, in various further implementations, causing the display to display the first link and the second link is causing the display to concurrently display the first link and the second link. In some such implementations, the links including the favicons are displayed as search results. Thus, in some such implementations, causing the display to concurrently display the first link and the second link is causing the display to display search results including the first link and the second link.

In various implementations, the method further comprises receiving the first favicon from the first web resource and the second favicon from the second web resource. In some such implementations, determining the first visual attribute and the second visual attribute further comprises modifying the first favicon according to the first visual attribute and modifying the second favicon according to the second visual attribute.

Calculation of the respective trust scores of the first web resource and the second web resource may be based on various types of information obtained from various information sources. In various implementations, at least one of calculating the first trust score and calculating the second trust score comprises receiving and evaluating information from a corresponding one of the first web resource and the second web resource. In various implementations, receiving and evaluating the information includes receiving and evaluating a digital certificate issued by a trusted third party. In various implementations, receiving and evaluating the information includes receiving and evaluating web content. In various implementations, evaluating the web content includes identifying at least one of contact information and banking information. In some such implementations, the method further comprises receiving trusted information from a trusted third party and verifying the at least one of contact information and banking information against the trusted information. In various implementations, evaluating the web content includes determining a content type of the content. In various implementations, evaluating the web content includes determining at least one of a number and a type of advertisements. In various implementations, evaluating the web content includes evaluating at least one of an integrity and a responsiveness of a link provided by the corresponding one of the first web resource and the second web resource. In various implementations, evaluating the web content includes evaluating a linked web resource to which a link included in the web content refers. In some such implementations, evaluating the linked web resource includes evaluating a trust score of the linked web resource.

In various implementations, at least one of calculating the first trust score and calculating the second trust score comprises receiving and evaluating metadata about a corresponding one of the first web resource and the second web resource. In various implementations, the metadata includes information contained in a response to a WHOIS query in respect of the corresponding one of the first web resource and the second web resource. In various implementations, the metadata includes an indication of a frequency with which the corresponding one of the first web resource and the second web resource was selected from among search results provided to users of a search engine. In various implementations, the metadata includes an indication of an age of the corresponding one of the first web resource and the second web resource. In various implementations, the metadata includes a history of the corresponding one of the first web resource and the second web resource. In various implementations, the metadata includes at least one of a freshness of content and a frequency of content updates of the corresponding one of the first web resource and the second web resource. In various implementations, the metadata includes at least one of a quantity of content and a quantity of registered users of the corresponding one of the first web resource and the second web resource. In various implementations, the metadata includes an estimated geographical location of the corresponding one of the first web resource and the second web resource. In various implementations, the metadata includes a rank of the corresponding one of the first web resource and the second web resource relative to at least one other web resource based on a criterion. In some such implementations, the criterion includes web analytics information. In some such implementations, receiving and evaluating the metadata comprises receiving the rank from a ranking server having calculated the rank.

One or a combination of visual attribute types may be used to indicate the trust score of one or more web resources in various implementations. Thus, in various implementations, at least one of the first visual attribute and the second visual attribute includes a size. In various implementations, at least one of the first visual attribute and the second visual attribute includes at least one of a color and a colorfulness. In various implementations, at least one of the first visual attribute and the second visual attribute includes a shape. In various implementations, at least one of the first visual attribute and the second visual attribute includes a degree of transparency. In various implementations, at least one of the first visual attribute and the second visual attribute includes an animation. In various implementations, at least one of the first visual attribute and the second visual attribute includes a position. In various implementations, at least one of the first visual attribute and the second visual attribute includes a superposition of at least one of a graphical element and text. In various implementations, each of the first visual attribute and the second visual attribute is one of a size, a color, a colorfulness, a shape, a degree of transparency, an animation, a position, a superposition of a graphical element, and a superposition of text.

The present technology may also be implemented as an electronic device or a server structured and configured to execute above-described methods. Thus, in another aspect, various implementations of the present technology provide an electronic device for presenting trust information in respect of web resources, the device comprising:
a display; and
at least one processor structured and configured to:
   determine a first visual attribute of a first favicon corresponding to a first web resource, the first visual attribute being indicative of a first trust score in respect of the first web resource, and a second visual attribute of a second favicon corresponding to a second web resource, the second attribute being indicative of a second trust score in respect of the second web resource; and
   cause the display to display a first link to the first web resource, the first link including the first favicon, and a second link to the second web resource, the second link including the second favicon.

In another aspect, various implementations of the present technology provide a server for presenting trust information in respect of web resources, the server comprising:
a communication interface structured and configured to communicate with an electronic device via a communications network; and
at least one processor structured and configured to
   determine a first visual attribute of a first favicon corresponding to a first web resource, the first visual attribute being indicative of a first trust score in respect of the first web resource, and a second visual attribute of a second favicon corresponding to a second web resource, the second attribute being indicative of a second trust score in respect of the second web resource; and
   cause the communication interface to send to the electronic device via the communications network instructions for displaying on a display of the electronic device a first link to the first web resource, the first link including the first favicon, and a second link to the second web resource, the second link including the second favicon.

The present technology may also be implemented as a non-transitory computer-readable storage medium storing program instructions executable by at least one processor of an electronic device or a server so as to execute above-described methods. Thus, in another aspect, various implementations of the present technology provide a non-transitory computer-readable storage medium storing program instructions for presenting trust information in respect of web resources, that when executed by at least one processor of an electronic device having a display, effect at least:
determining of a first visual attribute of a first favicon corresponding to a first web resource, the first visual attribute being indicative of a first trust score in respect of the first web resource, and a second visual attribute of a second favicon corresponding to a second web resource, the second attribute being indicative of a second trust score in respect of the second web resource; and
displaying on the display of a first link to the first web resource, the first link including the first favicon, and a second link to the second web resource, the second link including the second favicon.

In another aspect, various implementations of the present technology provide a non-transitory computer-readable storage medium storing program instructions for presenting trust information in respect of web resources, that when executed by at least one processor of a server in communication with an electronic device via a communications network, effect at least:
determining of a first visual attribute of a first favicon corresponding to a first web resource, the first visual attribute being indicative of a first trust score in respect of the first web resource, and a second visual attribute of a second favicon corresponding to a second web resource, the second attribute being indicative of a second trust score in respect of the second web resource; and
sending to the electronic device of instructions for displaying on a display of the electronic device a first link to the first web resource, the first link including the first favicon, and a second link to the second web resource, the second link including the second favicon.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first icon” and “second icon” is not intended to imply any particular order, type, chronology, hierarchy or ranking (for example) of/between the icons, nor is their use (by itself) intended imply that any “second icon” must necessarily exist in any given situation. Further, as is discussed herein in other contexts, reference to a “first” element and a “second” element does not preclude the two elements from being the same actual real-world element. Thus, for example, in some instances, a “first” icon and a “second” icon may be the same icon, and in other cases they may be different icons.

In the context of the present specification, a first device should be understood to be “in communication with” a second device if each of the devices is capable of sending information to and receiving information from the other device, across any physical medium or combinations of physical media, at any distance, and at any speed. As a non-limiting example, two electronic device(s) may communicate over a computer network such as the Internet. As another non-limiting example, the devices may run on the same electronic hardware, in which case communication may occur by any means available on such electronic hardware, such as inter-process communication.

In the context of the present specification, the expression “information” includes information of any nature or kind whatsoever capable of being stored on a non-transitory computer-readable storage medium. Therefore information includes, but is not limited to audiovisual works (pictures, movies, sound recordings, presentations etc.), data (location data, numerical data, etc.), text (opinions, comments, questions, messages, etc.), documents, spreadsheets, program instructions, etc.

In the context of the present specification, the expression “non-transitory computer-readable storage medium” is intended to include memory and media of any nature and kind whatsoever, including RAM, ROM, disks (CD-ROMs, DVDs, floppy disks, hard drives, etc.), USB flash drives, solid-state drives, tape drives, etc.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and, further features thereof, reference is made to the following description which is to be used in conjunction with the accompanying drawings, where:

FIG. 1 is a context diagram of a computing environment suitable for use with implementations of the present technology described herein;

FIG. 2 is an exemplary screenshot of a display showing links including favicons displayed according to some implementations of the present technology;

FIG. 3 is a flowchart representing a series of steps for presenting trust information in respect of web resources using favicons, illustrating various implementations of the present technology;

FIG. 4 is a flowchart representing a series of steps for presenting trust information in respect of web resources using favicons, illustrating standalone and client-side implementations of the present technology;

FIG. 5 is a flowchart representing a series of steps for presenting trust information in respect of web resources using favicons, illustrating server-side implementations of the present technology;

FIG. 6 is a flowchart representing a series of steps for presenting trust information in respect of web resources using favicons, illustrating passive implementations of the present technology;

FIG. 7 is a flowchart representing a series of steps for presenting trust information in respect of web resources using favicons, illustrating standalone and client-side implementations of the present technology which receive trust scores from a trust score server;

FIG. 8 is a flowchart representing a series of steps for presenting trust information in respect of web resources using favicons, illustrating server-side implementations of the present technology which receive trust scores from a trust score server;

FIG. 9 is a flowchart representing a series of steps for presenting trust information in respect of web resources using favicons, illustrating complete standalone and client-side implementations of the present technology; and

FIG. 10 is a flowchart representing a series of steps for presenting trust information in respect of web resources using favicons, illustrating complete server-side implementations of the present technology.

### DETAILED DESCRIPTION

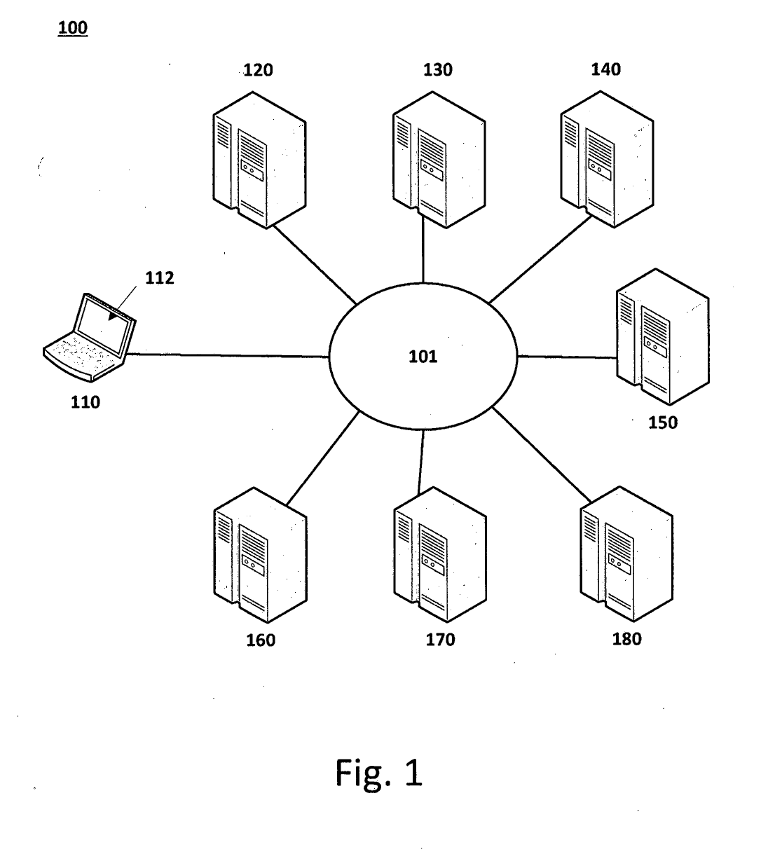

FIG. 1 shows a context diagram of a computing environment 100 suitable for use with implementations herein. Notebook computer 110 has a display 112 and a web browser configured to display webpages on display 112. In alternative implementations, any other suitable electronic device having a display could be substituted for notebook computer 110. Web servers 120, 130, and 140 are standard web servers, each hosting a respective website. The website hosted by web server 130 includes a hyperlink to a webpage hosted by web server 140. Each of the websites hosted by web servers 120, 130, and 140 is included in a search index (not depicted) of search engine 150, which is one or more servers implementing a search engine system capable of responding to search queries with search results. Information server 160 is a server implementing several protocols allowing it to respond to requests for information in respect of web servers 120, 130, and 140. In an exemplary implementation, information server 160 could be configured as a WHOIS server with a WHOIS database including records for each of web servers 120, 130, and 140. Web analytics server 170 maintains a ranking of various websites including those hosted by web servers 120, 130, and 140, the ranking being based on web analytics criteria. As a non-limiting example, web analytics server 170 could be an Alexa Internet™ server and the ranking could be its “top sites” ranking. Trust score server 180 is a server which evaluates trust scores of web resources such as the websites hosted by web servers 120, 130, and 140, and provides trust scores in response to queries in respect of particular web resources. Each of notebook computer 110, web servers 120, 130, and 140, search engine 150, information server 160, web analytics server 170, and trust score server 180 is connected to the Internet 101, thereby allowing communication between any two of these devices. In alternative implementations, communication between devices may be carried out over any number of public and/or private communications networks.

It is to be expressly understood that computing environment 100 comprises just some implementations of the present technology, and the description thereof that follows is intended to be only a description of illustrative examples of the present technology. This description is not intended to define the scope or set forth the bounds of the present technology. In some cases, what are believed to be helpful examples of modifications to computing environment 100 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. It is also to be understood that the computer systems 100 may provide in certain instances simple implementations of the present technology and that, where such is the case, they have been presented in this manner as an aid to understanding. As persons skilled in the art would understand, various implementations of the present technology may be of a greater complexity.

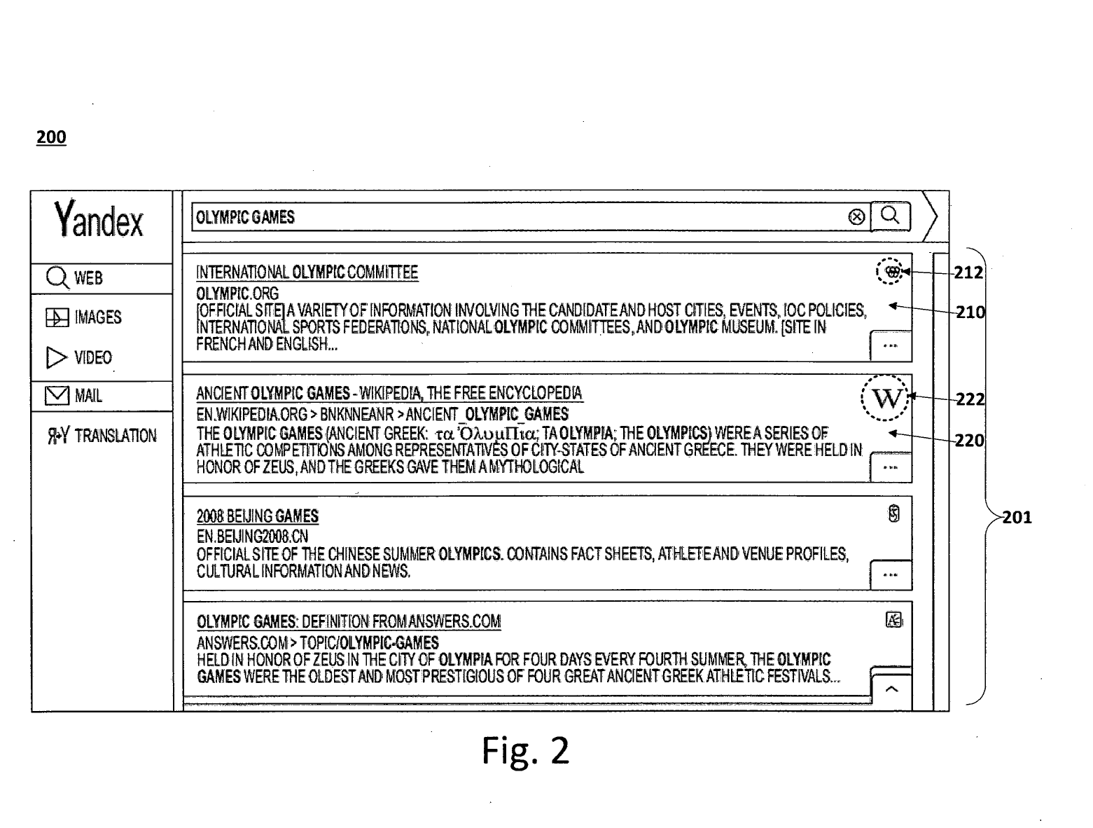

FIG. 2 shows an exemplary search engine results page 200 which could be displayed on display 112 of notebook computer 110 (shown in FIG. 1) according to some implementations of the present technology. The search engine results page 200 includes search results 201 comprising links to web resources. A first link 210 includes a first favicon 212 corresponding to the web resource to which the first link 210 refers, which is the website of the International Olympic Committee (IOC) in this example. A second link 220 includes a second favicon 222 corresponding to the web resource to which the second link 220 refers, which in this case is a webpage about the ancient Olympic games on the Wikipedia website. Each of favicon 212 and favicon 222 is displayed with a different size, the size of each favicon being indicative of a respective trust score of each of the IOC website and the Wikipedia website. In the example shown, the bigger size of favicon 222 relative to favicon 212 could be indicative of a higher trust score of the Wikipedia website relative to that of the IOC website.

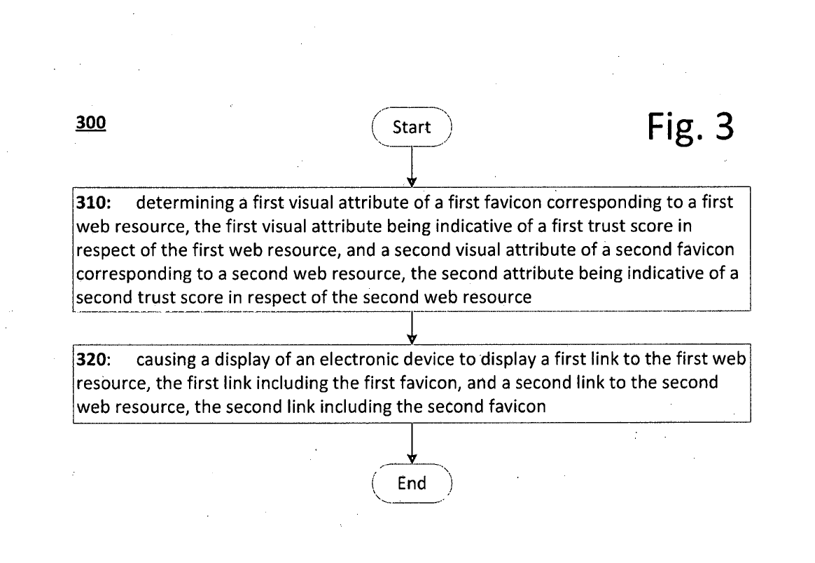

FIGS. 3 to 10 depict various methods implementing the present technology. They are described hereinbelow with reference to the exemplary computing environment 100 of FIG. 1 for the purpose of illustrating their various features.

FIG. 3 depicts a method 300 for presenting trust information in respect of web resources on a display of an electronic device according to various implementations of the present technology. At step 310, a first visual attribute of a first favicon corresponding to a first web resource, the first visual attribute being indicative of a first trust score in respect of the first web resource, and a second visual attribute of a second favicon corresponding to a second web resource, the second attribute being indicative of a second trust score in respect of the second web resource are determined. At step 320, displaying on the display of a first link to the first web resource, the first link including the first favicon, and a second link to the second web resource, the second link including the second favicon, is caused.

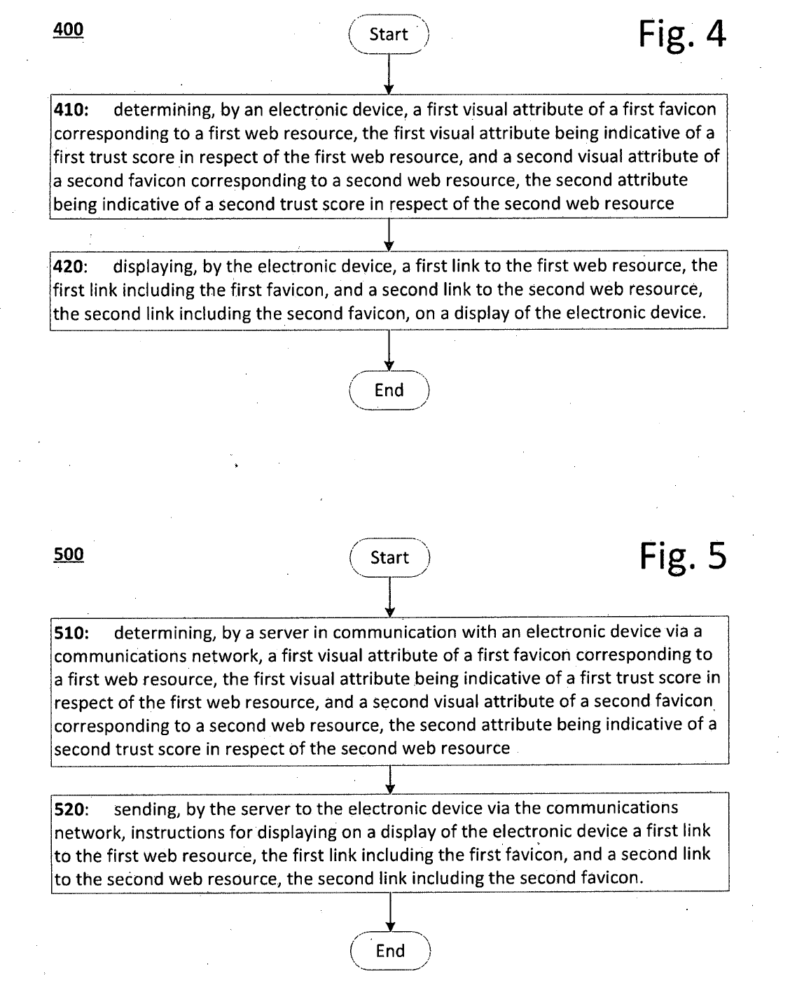

FIG. 4 depicts a method 400 which is a version of method 300 just described wherein each of the steps is executed by the electronic device itself. Thus, at step 410, the first visual attribute and the second visual attribute are determined by the electronic device; and at step 420 the first link and the second link are displayed by the electronic device on the display. Method 400 therefore exemplifies various implementations of the present technology executable by a standalone or client device. With reference to FIG. 1, this could be notebook computer 110, for example.

FIG. 5 depicts a method 500 which is a version of method 300, described above, wherein each of the steps is executed by a server in communication with the electronic device via a communications network. Thus, at step 510, the first visual attribute and the second visual attribute are determined by the server; and at step 520 instructions for displaying the first link and the second link are sent by the server to the electronic device, thus causing the display to display the first link and the second link. Method 500 therefore exemplifies various implementations of the present technology executable by one or more servers in communication with the electronic device. With reference to FIG. 1, the server could be search engine 150 and the electronic device could be notebook computer 110, for example.

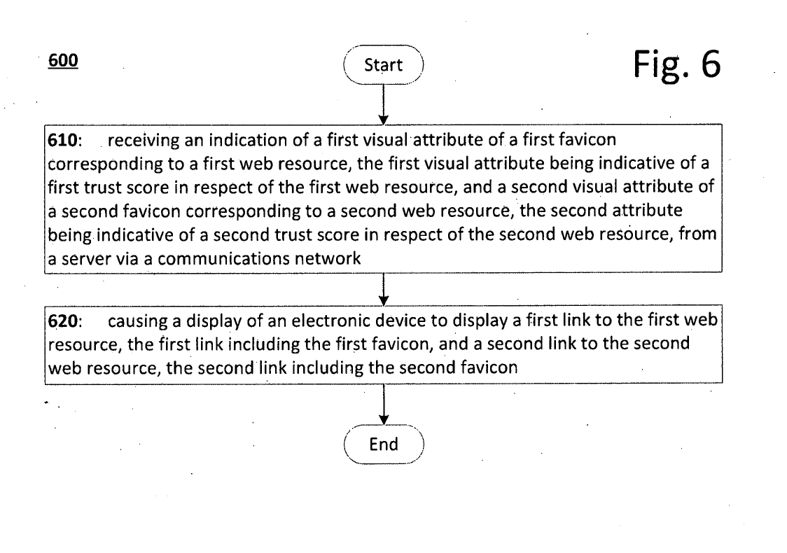

FIG. 6 depicts a method 600 which is a version of method 300, described above, wherein the visual attributes with which the first favicon and the second favicon are to be displayed are determined passively, namely by being received from a server. Thus, at step 610, an indication of the first visual attribute and an indication of the second visual attribute are received from a server, and at step 620, displaying on the display of the electronic device of the first link and the second link is caused. Method 600 therefore exemplifies various implementations of the present technology executable either by a passive client device which simply displays favicons with visual attributes provided to it by a server, or by a forwarding server which receives indications of the visual attributes with which the favicons are to be displayed and then causes a client device with which it is in communication via a communications network to display them on its display. With reference to FIG. 1, notebook computer 110 could be such a passive client device, perhaps receiving the indications of the visual attributes with which to display the favicons from search engine 150. An example of a forwarding server is not depicted in FIG. 1, though those skilled in the art will understand that such a server could easily be added, for example, as an intermediary web server which implements method 600 so as to receive indications of visual attributes of favicons from search engine 150 and cause notebook computer 110 to display the favicons on display 112 with those visual attributes.

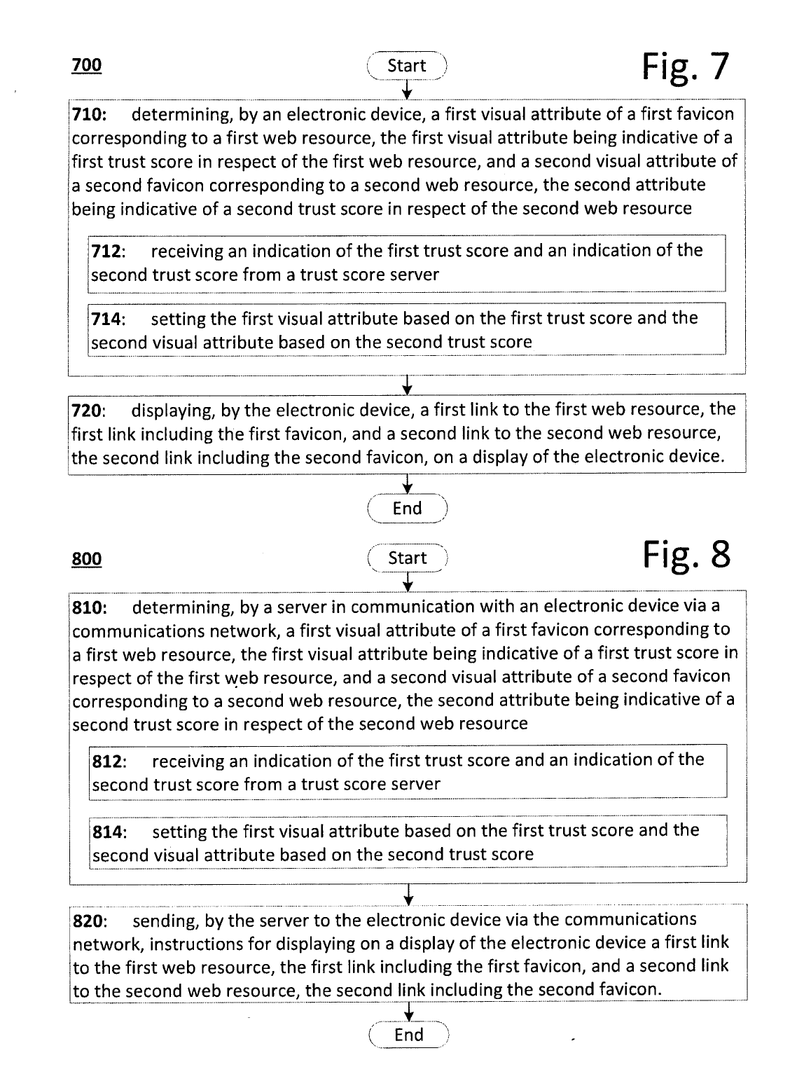

FIG. 7 depicts a method 700 which is a version of method 400 described above, wherein the determination of the first visual attribute and the second visual attribute includes receiving respective trust scores in respect of each of the first web resource and the second web resource from a trust score server. Thus, at step 710, the first visual attribute and the second visual attribute are determined by the electronic device, wherein that determination includes steps 712 and 714. At step 712, an indication of the first trust score and an indication of the second trust score are received from a trust score server by the electronic device. At step 714, the first visual attribute is set by the electronic device based on the first trust score and the second visual attribute is set by the electronic device based on the second trust score. At step 720, the electronic device displays the first link and the second link on its display, each link including a respective favicon being displayed with a respective visual attribute as set at step 714. Method 700 therefore exemplifies various implementations of the present technology executable by a client device which interacts with a trust score server to obtain trust scores in respect of various web resources. With reference to FIG. 1, the electronic device could be notebook computer 110, the trust score server could be trust score server 180, and the web resources could be websites hosted by web servers 120, 130, and 140.

FIG. 8 depicts a method 800 which is a version of method 500 described above, wherein the determination of the first visual attribute and the second visual attribute includes receiving respective trust scores in respect of each of the first web resource and the second web resource from a trust score server. This is similar to method 700 just described, only it is executed by a server in communication with the electronic device rather than by the electronic device itself. Thus, at step 810, the first visual attribute and the second visual attribute are determined by the server, wherein that determination includes steps 812 and 814. At step 812, an indication of the first trust score and an indication of the second trust score are received from a trust score server by the server. At step 814, the first visual attribute is set by the server based on the first trust score and the second visual attribute is set by the server based on the second trust score. At step 820, the server sends instructions for displaying the first link and the second link to the electronic device, causing it to display the first link and the second link on its display, each link including a respective favicon being displayed with a respective visual attribute as set at step 814. Method 800 therefore exemplifies various implementations of the present technology executable by a server which interacts with a trust score server to obtain trust scores in respect of various web resources, the server being in communication with a client device which it causes to display the links with favicons indicative of the respective trust scores of the corresponding web resources. With reference to FIG. 1, the server could be search engine 150, the trust score server could be trust score server 180, the web resources could be websites hosted by web servers 120, 130, and 140, and the client device could be notebook computer 110.

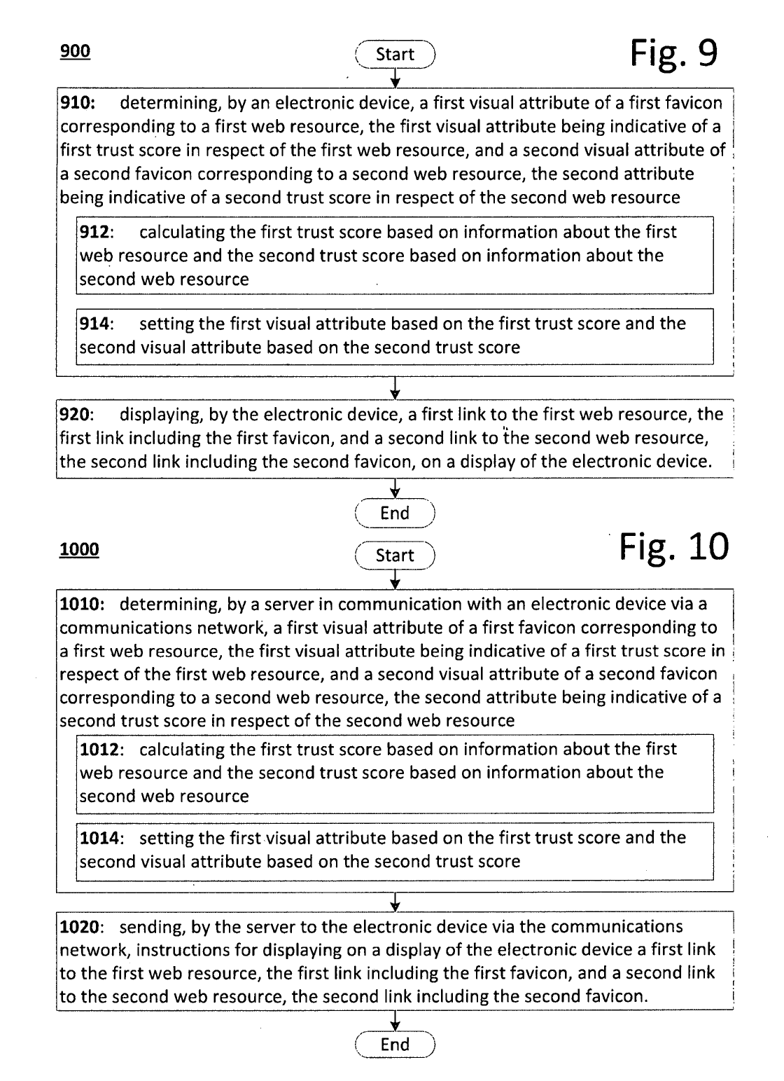

FIG. 9 depicts a method 900 which is a version of method 400 described above, wherein the determination of the first visual attribute and the second visual attribute includes calculating respective trust scores in respect of each of the first web resource and the second web resource based on respective information about those web resources. Thus, at step 910, the first visual attribute and the second visual attribute are determined by the electronic device, wherein that determination includes steps 912 and 914. At step 912, the first trust score is calculated by the electronic device based on information about the first web resource and the second trust score is calculated by the electronic device based on information about the second web resource. At step 914, the first visual attribute is set by the electronic device based on the first trust score and the second visual attribute is set by the electronic device based on the second trust score. At step 920, the electronic device displays the first link and the second link on its display, each link including a respective favicon being displayed with a respective visual attribute as set at step 914. Method 900 therefore exemplifies various implementations of the present technology executable by a standalone client device which calculates trust scores in respect of various web resources and displays favicons corresponding to those web resources with visual attributes indicative of those respective trust scores. With reference to FIG. 1, the electronic device could be notebook computer 110, and the web resources could be websites hosted by web servers 120, 130, and 140.

FIG. 10 depicts a method 1000 which is a version of method 500 described above, wherein the determination of the first visual attribute and the second visual attribute includes calculating respective trust scores in respect of each of the first web resource and the second web resource based on respective information about those web resources. This is similar to method 900 just described, only it is executed by a server in communication with the electronic device rather than by the electronic device itself. Thus, at step 1010, the first visual attribute and the second visual attribute are determined by the server, wherein that determination includes steps 1012 and 1014. At step 1012, the first trust score is calculated by the server based on information about the first web resource and the second trust score is calculated by the server based on information about the second web resource. At step 1014, the first visual attribute is set by the server based on the first trust score and the second visual attribute is set by the server based on the second trust score. At step 1020, the server sends instructions for displaying the first link and the second link to the electronic device, causing it to display the first link and the second link on its display, each link including a respective favicon being displayed with a respective visual attribute as set at step 1014. Method 1000 therefore exemplifies various implementations of the present technology executable by a comprehensive server which performs each of the steps of calculating trust scores in respect of web resources, setting visual attributes of favicons indicative of the trust scores, and causing a client device to display links to the web resources, the links including favicons with visual attributes indicative of the respective trust scores of the web resources. With reference to FIG. 1, the comprehensive server could be search engine 150, the web resources could be websites hosted by web servers 120, 130, and 140, and the client device could be notebook computer 110.

In variations of above methods, the first link and the second link could be displayed either sequentially, such that only one of the first link and the second link id displayed at one time, or concurrently, such that there is at least an instant during which both the first link and the second link are both displayed on the display. As an example of concurrent displaying, both the first link and the second link, each including a favicon indicative of the trust score of the corresponding web resource, could be displayed as search results in a listing of search results, such as the search engine results page 200 depicted in FIG. 2.

In variations of above methods, the first favicon is received from the first web resource and the second favicon is received from the second web resource. In some such variations, visual attributes of each of the first favicon and the second favicon are modified in order to convey the trust scores of the web resources they represent. In this way, the conventional use of favicons as conduits for branding information from operators of web resources to users may be preserved. Thus favicons may serve both as a means of conveying branding information and as a means of conveying trust information in respect of web resources.

Trust scores may be calculated on the basis of many different types of information about web resources, and many variations of above methods comprising calculating the first and second trust scores are envisioned. In some variations, at least one of calculating the first trust score and calculating the second trust score comprises receiving and evaluating information from a corresponding one of the first web resource and the second web resource. The trust score of a web resource may then be computed at least in part based on any relevant indicators present in information received from the web resource. For example, the information may include a digital certificate or trust certificate issued by a trusted third party, such as a digital security company or a certificate authority, and the trust score may be based on an evaluation of the digital certificate.

Other information that may be received and evaluated includes web content, which may include webpages, text, graphics, videos, sound clips, or any other content provided by a web resource. The evaluation may include identifying various types of information such as contact information and/or banking information. In some variations the contact information and/or banking information could then be verified against trusted information received from a trusted third party. Non-limiting examples of potential trusted third parties include banks, registries maintained by public or private regulatory bodies, or internet authorities such as ICANN or WHOIS servers. Evaluating the web content could include determining a content type of the content, wherein content types could refer to types of media (text, pictures, sounds, etc . . . ) or types of content within a particular media type (text about current events, text expressing political opinions, text about cats). For example, evaluating web content may include determining at least one of a number and a type of advertisements included in the content. The functionality of the web resource may also be a consideration. For example, evaluating the web content may include evaluating the integrity or responsiveness of one or more links included in the content. In some variations, any linked web resources to which a link included in the web content refers may also be evaluated as part of calculating the linking web resource's trust score. The evaluation of such linked web resources could include, for example, evaluating a trust score of a linked web resource, as one may judge that web resources linking to linked web resources with low trust scores are themselves less worthy of trust.

Other information that may be received and evaluated includes metadata about web resources in respect of which trust scores are being computed. Such metadata may be, for example, information contained in a response to a WHOIS query in respect of a web resource, such as information about the registrant of the web resource's domain name. Other metadata that may also be taken into consideration includes a frequency with which the web resource was selected from among search results provided to users of a search engine. More popular sites may be more trustworthy than those that have failed to consistently attract and retain users. The age of a web resource, as determined for example by domain name registration date or based on an index maintained by a web crawler, may also be included in the metadata considered in some implementations. Similarly, the metadata may include a history of a web resource, perhaps tracked by a web crawler noting the evolution of a website, for example. Along the same lines, the freshness of content and/or the frequency with which it is updated may also be evaluated. Other considerations include the quantity of content available from a web resource and/or the quantity of users who have registered with it. The estimated geographical location of the web resource could also be taken into account when calculating the web resource's trust score. An estimate may be based, for example, on the IP address of the web server hosting the web resource.

Other metadata that may be used to calculate a web resource's trust score includes a rank of the web resource relative to at least one other web resource based on a criterion. The criterion could include web analytics information, such as that compiled by Alexa™ Various implementations may further comprise receiving the rank from a ranking server, which could be a search engine, a web analytics server, or any other server which can be queried to obtain a relative ranking of at least two web resources.

Depending on the implementation, a variety of different visual attributes of favicons or combinations of visual attributes of favicons may be used as indicators of the respective trust scores of web resources. As in FIG. 2, the size of the favicons may be varied, wherein larger favicons could be indicative either of higher or of lower trust scores than smaller favicons. The color or colorfulness with which favicons are displayed could also serve to indicate trust score, such that, for example, favicons shown in color are indicative of more trustworthy web resources and favicons shown in gray are indicative of less trustworthy web resources, or vice versa. Favicons could be given various shapes, with some shapes being indicative of higher or lower trust scores than other shapes. Favicons could be displayed with a degree of transparency indicative of a trust score. Trust scores could be indicated by animating some favicons and not others, or by animating them differently, or to varying degrees or at varying speeds. The position of favicons relative to other features of the link to which they belong, such as text, could be indicative of higher or lower trust scores. Favicons could have text and/or graphical elements superimposed on them, such as, for example, checkmarks, or a “no symbol” (the well-known circle with a slash through it commonly seen on “no smoking” and “no parking” signs), or simply a number indicating the trust score. Any number of other visual attributes of favicons being indicative of trust score may be envisioned, either individually or in combination with any one or combination of the abovementioned examples.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method of presenting trust information in respect of web resources on a display of an electronic device, the method comprising:
receiving first content information from a first web resource;
analysing the first content information and based on the first content information, determining a first trust score associated with the first web resource;
receiving second content information from a second web resource;
analysing second content information and based on the second content information, determining a second trust score associated with the second web resource;
receiving, from the first web resource, a first favicon corresponding to the first web resource, and receiving, from the second web resource, a second favicon corresponding to the second web resource;
determining a first visual attribute of the first favicon, the first visual attribute being indicative of the first trust score in respect of the first web resource, and a second visual attribute of the second favicon, the second visual attribute being indicative of the second trust score in respect of the second web resource;
modifying the first favicon according to the first visual attribute and modifying the second favicon according to the second visual attribute; and
causing the display to display search results including a first link to the first web resource, the first link including the first favicon modified according to the first visual attribute, and a second link to the second web resource, the second link including the second favicon modified according to the second visual attribute.

2. The method of claim 1, wherein:
determining the first visual attribute and the second visual attribute is determining, by the electronic device, the first visual attribute and the second visual attribute; and
causing the display to display the first link and the second link is displaying, by the electronic device, the first link and the second link on the display.

3. The method of claim 1, wherein:
determining the first visual attribute and the second visual attribute is determining, by a server in communication with the electronic device via a communications network, the first visual attribute and the second visual attribute; and
causing the display to display the first link and the second link is sending, by the server to the electronic device via the communications network, instructions for displaying the first link and the second link.

4. The method of claim 1, wherein determining the first visual attribute and the second visual attribute is receiving an indication of the first visual attribute and an indication of the second visual attribute from a server via a communications network.

5. The method of claim 2, wherein determining the first visual attribute and the second visual attribute comprises:
receiving an indication of the first trust score and an indication of the second trust score from a trust score server; and
setting the first visual attribute based on the first trust score and the second virtual attribute based on the second trust score.

6. The method of claim 2, wherein determining the first visual attribute and the second visual attribute comprises:
calculating the first trust score based on information about the first web resource and the second trust score based on information about the second web resource; and
setting the first visual attribute based on the first trust score and the second virtual attribute based on the second trust score.

7. The method of claim 1, wherein causing the display to display the first link and the second link is causing the display to concurrently display the first link and the second link.

8. The method of claim 7, wherein causing the display to concurrently display the first link and the second link is causing the display to display search results including the first link and the second link.

9-10. (canceled)

11. The method of claim 6, wherein at least one of calculating the first trust score and calculating the second trust score comprises receiving and evaluating information from a corresponding one of the first web resource and the second web resource.

12. The method of claim 11, wherein receiving and evaluating the information includes at least one of receiving and evaluating a digital certificate issued by a trusted third party; and receiving and evaluating web content.

13. (canceled)

14. The method of claim 12, wherein evaluating the web content includes at least one of: includes identifying at least one of contact information and banking information; determining a content type of the content; determining at least one of a number and a type of advertisements; evaluating at least one of an integrity and a responsiveness of a link provided by the corresponding one of the first web resource and the second web resource; and evaluating a linked web resource to which a link included in the web content refers.

15. The method of claim 12, further comprising receiving trusted information from a trusted third party and verifying the at least one of contact information and banking information against the trusted information.

16-20. (canceled)

21. The method of claim 1, wherein at least one of calculating the first trust score and calculating the second trust score comprises receiving and evaluating metadata about a corresponding one of the first web resource and the second web resource.

22. The method of claim 21, wherein the metadata includes at least one of: information contained in a response to a WHOIS query in respect of the corresponding one of the first web resource and the second web resource; an indication of a frequency with which the corresponding one of the first web resource and the second web resource was selected from among search results provided to users of a search engine; an indication of an age of the corresponding one of the first web resource and the second web resource; a history of the corresponding one of the first web resource and the second web resource; at least one of a freshness of content and a frequency of content updates of the corresponding one of the first web resource and the second web resource; at least one of a quantity of content and a quantity of registered users of the corresponding one of the first web resource and the second web resource; an estimated geographical location of the corresponding one of the first web resource and the second web resource; and a rank of the corresponding one of the first web resource and the second web resource relative to at least one other web resource based on a criterion.

23-31. (canceled)

32. The method of claim 1, wherein at least one of the first visual attribute and the second visual attribute includes at least one of: a size; a color; a colorfulness, a shape, a degree of transparency, an animation, a position, and a superposition of at least one of a graphical element and text.

33-39. (canceled)

40. An electronic device for presenting trust information in respect of web resources, the device comprising:
a display; and
at least one processor structured and configured to
receive first content information from a first web resource;
analyse the first content information and based on the first content information, determine a first trust score associated with the first web resource;
receive second content information from a second web resource;
analyse second content information and based on the second content information, determine a second trust score associated with the second web resource;
receive, from the first web resource, a first favicon corresponding to the first web resource, and receive, from the second web resource, a second favicon corresponding to the second web resource;
determine a first visual attribute of the first favicon, the first visual attribute being indicative of the first trust score in respect of the first web resource, and a second visual attribute of the second favicon, the second visual attribute being indicative of the second trust score in respect of the second web resource;
modify the first favicon according to the first visual attribute and modify the second favicon according to the second visual attribute; and
cause the display to display search results including a first link to the first web resource, the first link including the first favicon modified according to the first visual attribute, and a second link to the second web resource, the second link including the second favicon modified according to the second visual attribute.

41. A server for presenting trust information in respect of web resources, the server comprising:
a communication interface structured and configured to communicate with an electronic device via a communications network; and
at least one processor structured and configured to:
receive first content information from a first web resource;
analyse the first content information and based on the first content information, determine a first trust score associated with the first web resource;
receive second content information from a second web resource;
analyse second content information and based on the second content information, determine a second trust score associated with the second web resource;
receive, from the first web resource, a first favicon corresponding to the first web resource, and receive, from the second web resource, a second favicon corresponding to the second web resource;
determine a first visual attribute of the first favicon, the first visual attribute being indicative of the first trust score in respect of the first web resource, and a second visual attribute of the second favicon, the second visual attribute being indicative of the second trust score in respect of the second web resource;
modify the first favicon according to the first visual attribute and modify the second favicon according to the second visual attribute; and
cause the communication interface to send to the electronic device via the communications network instructions for displaying on a display of the electronic device search results including a first link to the first web resource, the first link including the first favicon modified according to the first visual attribute, and a second link to the second web resource, the second link including the second favicon modified according to the second visual attribute.

42-43. (canceled)
